(19) United States
(12) Patent Application Publication
(10) Pub. No.: US 2015/0377550 A1
(43) Pub. Date: Dec. 31, 2015

(54) LOW-TEMPERATURE LIQUEFIED GAS TANK

(71) Applicant: IHI Corporation, Tokyo (JP)

(72) Inventor: Yukitomo SAKAI, Tokyo (JP)

(73) Assignee: IHI CORPORATION, Tokyo (JP)

(21) Appl. No.: 14/849,713

(22) Filed: Sep. 10, 2015

Related U.S. Application Data
(63) Continuation of application No. PCT/JP2014/061590, filed on Apr. 24, 2014.

(30) Foreign Application Priority Data
May 15, 2013 (JP) 2013-103287

(51) Int. Cl. F25J 1/00; F17C 9/02

(52) U.S. Cl. CPC F25J 1/0025; F17C 9/02

(57) ABSTRACT

A low-temperature liquefied gas tank is a low-temperature liquefied gas tank including a storage tank configured to store a low-temperature liquefied gas, and a re-liquefaction facility configured to liquefy boil off gas generated in the storage tank. A returning unit configured to return a re-liquefaction boil off gas liquefied in the re-liquefaction facility to the storage tank is provided. The returning unit has a distributor disposed under a liquid surface of the low-temperature liquefied gas stored in the storage tank and configured to eject the re-liquefaction boil off gas into the low-temperature liquefied gas.

### TECHNICAL FIELD

The present disclosure relates to a low-temperature liquefied gas tank.

This application is a continuation application based on a PCT Patent Application No. PCT/JP2014/061590, filed Apr. 24, 2014, whose priority is claimed on Japanese Patent Application No. 2013-103287, filed May 15, 2013. The contents of both the PCT application and the Japanese Patent Application are incorporated herein by reference.

### BACKGROUND ART

In the related art, in a low-temperature liquefaction tank including a storage tank configured to store a low-temperature liquefied gas such as liquefied natural gas (LNG) or the like, a boil off gas (hereinafter referred to as BOG) generated by gasifying a low-temperature liquefied gas is re-liquefied to return to a liquefied gas as a form of a product. That is, the generated BOG is compressed and cooled in a re-liquefaction facility to be re-liquefied, a gas that is not liquefied using a gas/liquid separation drum is separated, and then the gas is returned to an upper section of the storage tank (for example, see Patent Document 1).

However, even when only the liquid from the gas/liquid separation drum is to be returned to the storage tank, in the re-liquefied BOG, some of the liquid is gasified when the pressure is decreased to a pressure in the storage tank. Here, since nitrogen is mixed with a low-temperature liquefied gas (for example, LNG), the nitrogen is relatively largely contained in a gasified gas due to a difference between boiling points of the low-temperature liquefied gas and the nitrogen. That is, the gasified gas returned to the storage tank is increased in nitrogen concentration. As such nitrogen is returned to an upper section of the storage tank, i.e., an upper side of a liquid surface of the low-temperature liquefied gas, the nitrogen is mixed with the BOG generated in the storage tank, and then delivered to the re-liquefaction facility again.

When the re-liquefaction cycle is continued as described above, the nitrogen concentration in the BOG is gradually increased. Then, when the nitrogen concentration is higher than a certain concentration, a phenomenon in which the BOG is not liquefied in the re-liquefaction facility occurs.

When the phenomenon in which the BOG is not liquefied occurs as described above, since the non-liquefied gas is separated in the gas/liquid separation drum to be delivered to a flare or the like to be discarded, it becomes uneconomical.

### DOCUMENT OF RELATED ART

### Patent Document

[Patent Document 1] Japanese Unexamined Patent Application, First Publication No. 2001-132899

### SUMMARY

### Technical Problem

Here, in Patent Document 1, a liquid in a saturated state obtained by cooling the BOG is separated into a gas and liquid and then cooled again, and returned to the storage tank in a supercooled state.

However, since the apparatus is complicated and energy cost is increased as the liquefied gas after the gas/liquid separation is cooled again to the supercooled state, both the manufacturing cost and operation cost of the low-temperature liquefied gas tank are increased.

In consideration of the above-mentioned circumstances, the present disclosure is directed to provide a low-temperature liquefied gas tank capable of limiting an increase in nitrogen concentration in BOG through a simple apparatus constitution, and thus limiting an increase in manufacturing cost or operation cost.

### Solution to Problem

A low-temperature liquefied gas tank of the present disclosure is a low-temperature liquefied gas tank including a storage tank configured to store a low-temperature liquefied gas, and a re-liquefaction facility configured to re-liquefy a boil off gas generated in the storage tank, the low-temperature liquefied gas tank having: a returning unit configured to return a re-liquefaction boil off gas liquefied in the re-liquefaction facility to the storage tank, wherein the returning unit has a distributor disposed under a liquid surface of a low-temperature liquefied gas stored in the storage tank and configured to eject the re-liquefaction boil off gas into the low-temperature liquefied gas.

In addition, in the low-temperature liquefied gas tank, the distributor may have a main pipeline disposed along an inner surface of a bottom section of the storage tank, and a plurality of holes may be formed at positions directed in a horizontal direction in a side surface of the main pipeline

In addition, in the low-temperature liquefied gas tank, the distributor may have a main pipeline disposed along an inner surface of a bottom section of the storage tank and a branch pipeline branched off from the main pipeline at a side portion thereof in a horizontal direction, and a plurality of holes may be formed at positions in the horizontal direction in a side surface of the branch pipeline.

### Effects of the Disclosure

According to the low-temperature liquefied gas tank of the present disclosure, the returning unit configured to return the re-liquefaction boil off gas to the storage tank has a distributor disposed at a lower side of the liquid surface of the low-temperature liquefied gas stored in the storage tank, and configured to eject the re-liquefaction boil off gas into the low-temperature liquefied gas. For this reason, even when some of the liquid decompressed to the pressure in the storage tank is gasified when the re-liquefaction boil off gas is returned to the storage tank, since the re-liquefaction boil off gas is ejected into the low-temperature liquefied gas by the distributor, the gasified gas in the re-liquefaction boil off gas is dissolved and absorbed into the low-temperature liquefied gas. Accordingly, since the nitrogen contained in the gasified gas at a high concentration is also absorbed into the low-temperature liquefied gas, the nitrogen is prevented from being mixed with the boil off gas generated in the storage tank, delivered to the re-liquefaction facility again, and circulated therethrough. Accordingly, it is possible to prevent an increase in nitrogen concentration in the boil off gas and non-liquefaction of the boil off gas in the re-liquefaction facility, and it is possible to reduce loss due to waste of the non-liquefied gas.

In addition, since it is possible to limit an increase in nitrogen concentration in the boil off gas through a simple configuration including only a distributor, it is possible to limit an increase in manufacturing cost or operation cost.

### BRIEF DESCRIPTION OF DRAWINGS

FIG. 1 is a configuration view schematically showing an embodiment of a low-temperature liquefied gas tank of the present disclosure.

FIG. 2A is a view taken along line A-A of FIG. 1.

FIG. 2B is a plan view of a major part of a main pipeline.

FIG. 2C is a side view of the major part of the main pipeline.

FIG. 3 is a plan view showing a major part of a variant of a distributor.

### DESCRIPTION OF EMBODIMENTS

Hereinafter, a low-temperature liquefied gas tank of the present disclosure will be described in detail with reference to the accompanying drawings. Further, in the following drawings, the scale of each member may be appropriately varied such that each member is recognizable.

FIG. 1 is a configuration view schematically showing an embodiment of a low-temperature liquefied gas tank of the present disclosure. FIG. 1 shows a low-temperature liquefied gas tank 1, and a storage tank 2. The storage tank 2 is configured to store a low-temperature liquefied gas such as liquefied natural gas (LNG) or liquefied petroleum gas (LPG), and further, methane, ethane, propane, or the like. In the embodiment, the storage tank 2 is a tank configured to store the liquefied natural gas (LNG) 3.

The storage tank 2 is configured to include an inner tank formed of, for example, a metal, and an outer tank formed of concrete. The inner tank is a container configured to directly store a liquefied gas, and the outer tank is a container configured to surround and accommodate the inner tank. An insulating material, a liner, or the like, is accommodated between the inner tank and the outer tank to form an insulating layer.

A discharge pipeline 4 configured to discharge the LNG 3 stored in the inside (in the inner tank) to the outside is installed at the storage tank 2 configured as described above. One end side of the discharge pipeline 4 is disposed at a bottom section 2a side in the storage tank 2, and the discharge pipeline 4 is disposed to pass through a roof section 2b of the storage tank 2 to be extracted to the outside, and then extend to a header (not shown). In addition to the storage tank 2, a discharge pipeline (not shown) from another storage tank (not shown) is also connected to the header, and LNG discharged from a discharge pipeline is transferred to a predetermined place.

In addition, a re-liquefaction facility 6 configured to re-liquefy a boil off gas (BOG) generated in the storage tank 2 is connected to the storage tank 2 via a pipeline 5. One end of the pipeline 5 is connected to the roof section 2b of the storage tank 2, and the other end is connected to the re-liquefaction facility 6. Accordingly, the pipeline 5 sends the BOG generated in the storage tank 2 and remaining over a liquid surface 3a of the LNG 3 to the re-liquefaction facility 6.

The re-liquefaction facility 6 is configured to include a compressor 7 connected to the pipeline 5, and a cooler 9 connected to the compressor 7 via a pipeline 8. For example, the compressor 7 is a compressor configured to compress the BOG to about 450 kPaA (4.58872 kg/cm²A), and extracts the compressed BOG to the cooler 9 via the pipeline 8.

The cooler 9 is configured as in the related art, and cools the BOG sent from the compressor 7 to a temperature liquefied at the pressure thereof, for example, about −168° C., and liquefies (re-liquefies) the compressed BOG. A gas/liquid separation drum 11 is connected to the cooler 9 via a pipeline 10.

The gas/liquid separation drum 11 is an apparatus configured to separate the re-liquefied BOG into a gas and liquid, a pipeline 12 configured to discharge the separated gas is connected to an apex section, and a pipeline 13 configured to extract the separated liquid is connected to a bottom section thereof.

An opening/closing valve 14 is installed at the pipeline 12. However, in the embodiment, as described above, since all of the BOG sent to the re-liquefaction facility 6 is re-liquefied, and thus the nitrogen in the BOG is not gasified either, almost no gas is separated in the gas/liquid separation drum 11. Accordingly, the opening/closing valve 14 is always closed.

A valve 15 is also installed at the pipeline 13. The valve 15 is always opened while re-liquefaction processing of the BOG is performed, and functions to reduce a pressure of the re-liquefied BOG passing through the valve 15 to the pressure in the storage tank 2. In addition, a front end side (an opposite side of the gas/liquid separation drum 11) of the pipeline 13 passes through the roof section 2b of the storage tank 2 to be disposed at the bottom section 2a side in the storage tank 2. A distributor 16 is connected to a front end section of the pipeline 13.

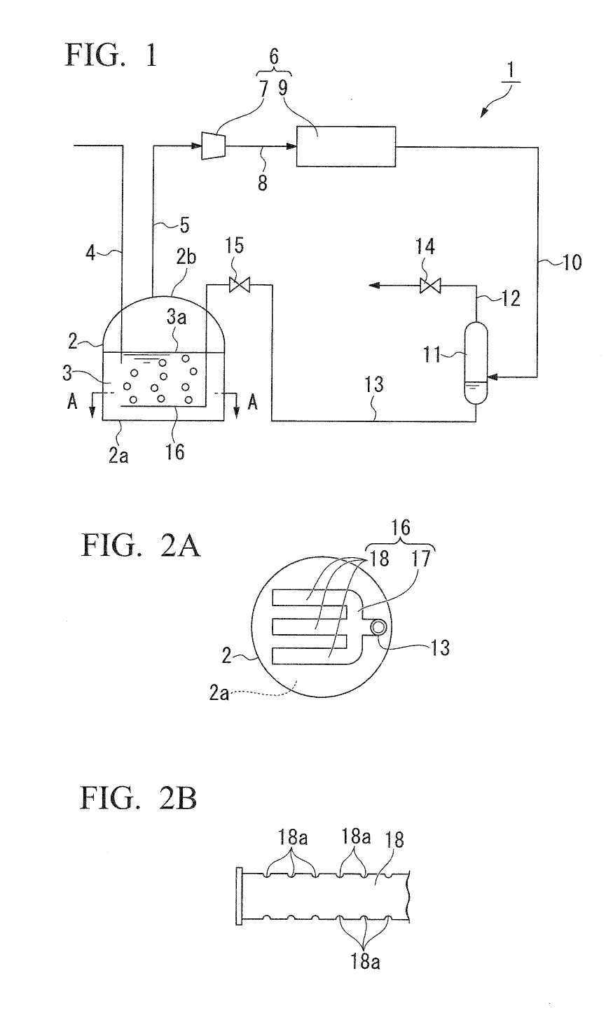

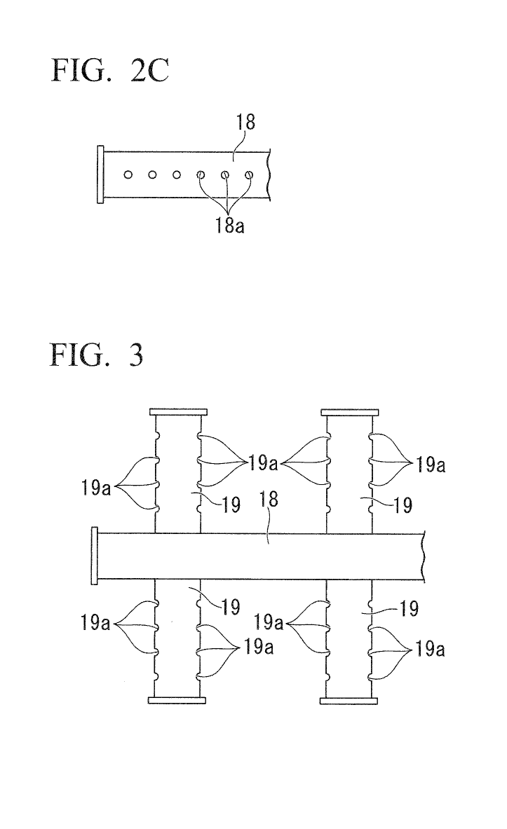

The distributor 16 is a pipe-shaped apparatus disposed at the bottom section 2a of the storage tank 2 along an inner surface of the bottom section 2a, i.e., slightly an upper side of the inner surface. Accordingly, the distributor 16 is disposed at a sufficiently lower side of the liquid surface 3a of the LNG 3 stored in the storage tank 2. In the embodiment, as shown in FIG. 2A taken along line A-A of FIG. 1, the distributor 16 is configured to have a branch pipe 17 connected to the pipeline 13, and three main pipelines 18 connected to the branch pipe 17.

Front ends of the branch pipe 17 and the main pipelines 18 are closed. The three main pipelines 18 are disposed in parallel to each other, and disposed at the same level (height) such that a surface on which the three main pipelines 18 are formed is parallel to an inner surface of the bottom section 2a. In addition, as the main pipelines 18 are disposed at appropriate intervals, the main pipelines are disposed to be uniformly positioned throughout the entire region of the inner surface of the bottom section 2a without deviation.

In addition, as shown in 2B serving as a plan view of the major part and FIG. 2C serving as a side view of the major part, a plurality of holes 18a are formed in the main pipeline 18 at positions directed in the horizontal direction of both side surfaces in a horizontal direction. These holes 18a are formed in a circular shape having an inner diameter of, for example, about several mm, and tens to hundreds of holes are formed in a lengthwise direction of the main pipeline 18 at equal intervals.

Further, a returning unit according to the present disclosure is constituted by the distributor 16 including the main pipeline 18 and the branch pipe 17, the pipeline 13, the gas/liquid separation drum 11, and the pipeline 10.

In the low-temperature liquefied gas tank having the above-mentioned configuration, when an operation of the re-liquefaction of the BOG is performed in the same manner as in the related art, the BOG that has undergone re-liquefaction processing in the re-liquefaction facility 6, i.e., the re-liquefied BOG, is introduced into the gas/liquid separation drum 11. However, in the embodiment to be described below, since the phenomenon in which the BOG is not liquefied in the re-liquefaction facility 6 does not occur, the BOG is introduced into the storage tank 2 through the pipeline 13 as it is when pressurized by the compressor 7 in the re-liquefaction facility 6 without separation of the gas component.

Here, since the re-liquefied BOG is returned to a relatively low pressure in the storage tank 2 from a high pressure state after compression by the compressor 7, nitrogen having a lower boiling point than methane serving as a main component of the LNG 3 is first gasified, and becomes minute air bubbles in the re-liquefied BOG. Then, the re-liquefied BOG having the air bubbles formed of such nitrogen gas arrives at the distributor 16 through the pipeline 13 to be ejected into the LNG 3 from the plurality of holes 18a formed in the side surfaces thereof.

Then, as the nitrogen gas in the re-liquefied BOG is introduced into the LNG 3 in the minute air bubble state, the nitrogen gas is dissolved and absorbed into the LNG 3 while the nitrogen gas rises in the LNG 3 from the bottom section 2a side toward the liquid surface 3a. Accordingly, in the related art, the re-liquefied BOG is returned to a space section closer to the roof section 2b than the liquid surface 3a of the LNG 3 in the storage tank 2, and thus the gasified (evaporated) nitrogen in the re-liquefied BOG stays in the space section and a concentration thereof is gradually increased, whereas, in the embodiment, almost no nitrogen in the re-liquefied BOG stays in the space section because the nitrogen is dissolved and absorbed into the LNG 3. For this reason, there is no increase in nitrogen concentration in the space section, and thus the concentration of the nitrogen contained in the BOG extracted from the space section to the re-liquefaction facility 6 by the re-liquefaction operation is substantially uniformly maintained without an increase according to the circulation due to the re-liquefaction operation.

In the low-temperature liquefied gas tank 1 of the embodiment, the returning unit configured to return the re-liquefied BOG into the storage tank 2 has the distributor 16 disposed under the liquid surface 3a of the LNG 3 stored in the storage tank 2 and configured to eject the re-liquefied BOG into the LNG 3. For this reason, even when some of the re-liquefied BOG is gasified, since the re-liquefied BOG is ejected into the LNG 3 by the distributor 16, the gasified gas in the re-liquefied BOG is dissolved and absorbed into the LNG 3.

Accordingly, the nitrogen contained in the gasified gas at a high concentration is also absorbed into the LNG 3. For this reason, the nitrogen is prevented from being mixed with the BOG generated in the storage tank 2 to be sent to the re-liquefaction facility 6 again and circulated. Accordingly, it is possible to prevent an increase in nitrogen concentration in the BOG and non-liquefaction of the BOG in the re-liquefaction facility 6, and reduce loss of the gas due to waste of the non-liquefied gas.

In addition, since it is possible to limit an increase in nitrogen concentration in the BOG through a simple configuration including only the distributor 16, an increase in manufacturing cost or operation cost can be limited.

In addition, a configuration in which the main pipeline 18 disposed along an inner surface of the bottom section 2a of the storage tank 2 is provided as the distributor 16 and a plurality of holes 18a are formed at positions in a horizontal direction in a side surface of the main pipeline 18 is used. For this reason, the re-liquefied BOG is substantially ejected from both sides of the main pipeline 18, and thus the nitrogen gas in the re-liquefied BOG is also uniformly distributed at both sides of the main pipeline 18. Accordingly, since the nitrogen gas is substantially uniformly ejected into the LNG 3, the nitrogen gas is appropriately dissolved and absorbed into the LNG 3, and the liquid surface 3a is prevented from rising and staying in the space section.

In addition, as the three main pipelines 18 are disposed at the same level, the three main pipelines 18 are substantially uniformly disposed on the entire region of the inner surface of the bottom section 2a. For this reason, the re-liquefied BOG is introduced in a more uniformly distributed state in substantially the entire region in the storage tank 2, and thus the nitrogen gas in the re-liquefied BOG is more appropriately dissolved and absorbed into the LNG 3.

Further, the present disclosure is not limited to the embodiment but various modifications may be made without departing from the spirit of the present disclosure.

For example, in the embodiment, while the distributor 16 constituted by the branch pipe 17 and the three main pipelines 18 is used as a distributor as shown in FIGS. 2A, 2B and 2C, the present disclosure is not limited thereto but a distributor constituted in various shapes/configurations may be used.

For example, as shown in FIG. 3, a distributor having a configuration in which a plurality of branch pipelines 19 are installed at the main pipeline 18 and a plurality of holes 19a are formed in the branch pipeline 19 may be used. The branch pipelines 19 are installed to be branched at both sides of the main pipeline 19 toward both sides of the main pipeline 18 and in a horizontal direction thereof. Then, a plurality of holes 19a are formed in these branch pipelines 19 at positions directed in the horizontal direction of both side surfaces in a horizontal direction. These holes 19a have a circular shape having an inner diameter of, for example, about several mm, and tens of holes 19a are disposed in a lengthwise direction of the branch pipeline 19 at equal intervals.

Further, while the plurality of holes 18a may be formed in the main pipeline 18 even in this example, a structure in which the holes 18a are not formed as shown in FIG. 3 may also be provided.

According to the distributor having the above-mentioned configuration, the holes 19a configured to eject the re-liquefied BOG can be disposed more widely and substantially uniformly in the entire region of the inner surface of the bottom section 2a. For this reason, the re-liquefied BOG can be more appropriately distributed on the entire region in the storage tank 2. Accordingly, the nitrogen gas in the re-liquefied BOG can be more appropriately dissolved and absorbed into the LNG 3.

In addition, as the distributor according to the present disclosure, for example, the number of the main pipelines 18 is not limited to three, but an arbitrary number of main pipelines 18 may be provided according to an area or the like of the bottom section 2a. In addition, with regard to the shape, for example, the main pipeline may be formed by a ring-shaped (annular) pipe along an inner surface of a sidewall of the storage tank 2. In this case, large-diameter ring-shaped pipes and small-diameter ring-shaped pipes may be concentrically disposed and more widely and substantially uniformly disposed on the entire region of the inner surface of the bottom section 2a.

Further, even in the branch pipeline 19, the number thereof or the like may be arbitrarily set.

In addition, while the present disclosure is applied to the low-temperature liquefied gas tank for LNG in the embodiment, the present disclosure may be applied to a tank configured to store another low-temperature liquefied gas such as LPG, methane, ethane, propane, or the like.

### INDUSTRIAL APPLICABILITY

The present disclosure provides a low-temperature liquefied gas tank capable of limiting an increase in nitrogen concentration in a BOG through a simple apparatus configuration and thus limiting an increase in manufacturing cost or operation cost.

1. A low-temperature liquefied gas tank comprising a storage tank configured to store a low-temperature liquefied gas, and a re-liquefaction facility configured to re-liquefy a boil off gas generated in the storage tank, the low-temperature liquefied gas tank comprising:
a returning unit configured to return a re-liquefaction boil off gas liquefied in the re-liquefaction facility to the storage tank,
wherein the returning unit has a distributor disposed under a liquid surface of the low-temperature liquefied gas stored in the storage tank and configured to eject the re-liquefaction boil off gas into the low-temperature liquefied gas.

2. The low-temperature liquefied gas tank according to claim 1, wherein the distributor has a main pipeline disposed along an inner surface of a bottom section of the storage tank, and a plurality of holes are formed at positions directed in a horizontal direction in a side surface of the main pipeline.

3. The low-temperature liquefied gas tank according to claim 1, wherein the distributor has a main pipeline disposed along an inner surface of a bottom section of the storage tank and a branch pipeline branched off from the main pipeline at a side portion thereof in a horizontal direction, and a plurality of holes are formed at positions in the horizontal direction in a side surface of the branch pipeline.
